(19) United States
(12) Patent Application Publication
(10) Pub. No.: US 2008/0162735 A1
(43) Pub. Date: Jul. 3, 2008

(54) Methods and systems for prioritizing input/outputs to storage devices

(76) Inventors: Doug Voigt, Boise, ID (US); Michael K. Traynor, San Jose, CA (US); Santosh Ananth Rao, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/648,742

(22) Filed: Dec. 29, 2006

(51) Int. Cl. G06F 3/00; G06F 12/00

(52) U.S. Cl. 710/6; 711/151; 711/E12.075

(57) ABSTRACT

Embodiments include methods, apparatus, and systems for prioritizing input/outputs (I/Os) to storage devices. One embodiment includes a method that receives an input/output (I/O) command having a group number field and a priority number field at a target device. The method then generates a new priority value based on the group number field. The I/O command is processed at the target device with the new priority value.

### BACKGROUND

Host computers send input/output (I/O) requests to storage arrays to perform reads, writes, and maintenance. The storage arrays typically process the requests in a fraction of a second. In some instances, numerous hosts direct large numbers of requests toward a single storage array. If the array is not able to immediately process the requests, then the requests are queued.

I/O requests at a storage device are processed according to predefined priorities. Historically, Small Computer System Interface (SCSI) storage devices had limited information for use in prioritizing I/Os. This information included standard Initiator-Target-LUN (ITL) nexus information defined by SCSI and task control information. Effectively, SCSI protocol forced all I/Os through a particular ITL nexus and processed the I/Os with the same priority. Thus, all I/Os were processed with a same priority and quality of service (QoS). ITL nexus information is insufficient to distinguish I/Os according to application relevant priority or other QoS information.

In some storage systems, incoming I/Os include a unique initiator ID. This ID identifies the host or a port on the host, but does not identify the application. Since a single host can simultaneously execute numerous applications, several applications can send I/Os through a same host port and receive identical initiator IDs. Further, in virtual environments, applications can move between various ports. As such, the initiator ID alone will not provide sufficient information of the application that generated the I/O. Thus, assigning priorities to specific initiator IDs would not result in knowing which priorities are being assigned to which applications.

### BRIEF DESCRIPTION OF THE DRAWINGS

FIG. 1 is a block diagram of a storage system in accordance with an exemplary embodiment of the present invention.

FIG. 2A shows a table for generating priorities for I/O commands in accordance with an exemplary embodiment of the present invention.

FIG. 2B shows another table for generating priorities for I/O commands in accordance with an exemplary embodiment of the present invention.

FIG. 3 is a flow diagram for generating priorities for I/O commands in accordance with an exemplary embodiment of the present invention.

### DETAILED DESCRIPTION

Embodiments in accordance with the present invention are directed to apparatus, systems, and methods for prioritizing input/outputs (I/Os) to storage devices. One embodiment provides a method for extending the sophistication of QoS management through a specific use of the SCSI group number relative to the SCSI priority field.

Some I/Os following SCSI protocol include a priority field and group number field. Although the SCSI specification describes the existence and general intent of these fields, the specification does not express or suggest any relationship between the priority field and group number field. Even with a consistent way of interpreting the priority field, there are many systems wherein several operating systems (OSs) are independently generating priorities, possibly in overlapping ranges. For example if a new OS is added to a pre-existing system that has been using priorities, the newly consolidated system may experience priority conflicts that are difficult to resolve at the OS level.

One exemplary embodiment provides a method of modifying the meaning of the SCSI priority field based at least on the value in the SCSI group number field. For example, normally the priority field represents a strict ordering of I/O priority interpreted in real time. This interpretation of the priority field is maintained when no group number is sent in the I/O command. On the other hand, if the group number is specified in the I/O command, then the priority field is substituted or changed with an alternate value or interpretation.

The priority of an I/O command is changed according to one or more of various rules. By way of example, the priority field in SCSI commands is changed according to one or more of the following rules:
(1) The group number is used as an index into a table of priorities. The priority indicated by the table entry at the index indicated by the group number replaces the original priority.
(2) The group number is used as an index into one dimension of a two dimensional table, and the original priority is used as the index to the second dimension. The content of the resulting array entry replaces the original priority.
(3) Any combination of bits from the ITL nexus, group number, and/or priority is used as a key into a table of quality of service descriptors. The resulting descriptor includes various information including but not limited to priority, I/O usage parameters, bandwidth usage parameters, and/or other hints, such as burst or sequential access indicators.

In one exemplary embodiment, a relationship is defined between the group number of the SCSI command and the priority field of the SCSI command. This relationship establishes a prioritization of I/Os that effectively over-rides or replaces the standard interpretation of I/O priority in the original priority field of the SCSI command. Thus, exemplary embodiments provide methods of managing priority globally by enabling one set of priority or quality of service (QoS) information to modify another. Further, priority conflicts are resolved within the storage device without modifying priorities being generated by the hosts. These methods are applicable to non-virtual and virtual environments, such as a system that uses shared HBA's in virtual machine environments. In addition, arbitrarily complex priority interpretation is enabled by the two levels of priority or QoS information.

In one exemplary embodiment, host computers run different operating systems with multiple different applications simultaneously executing on each host computer. Thus, hosts make I/O requests (example, read and write requests) to storage devices with varying expectations for command completion times. Although these I/O requests can include a SCSI priority, this priority does not take into account current workloads in the storage device with regard to other hosts and applications contemporaneously accessing the storage device. Embodiments in accordance with the present invention provide a more flexible system for managing priorities of I/O requests from multiple different servers and applications.

As used herein “SCSI” standards for small computer system interface that defines a standard interface and command set for transferring data between devices coupled to internal and external computer busses. SCSI connects a wide range of devices including, but not limited to, tape storage devices, printers, scanners, hard disks, drives, and other computer hardware and can be used on servers, workstations, and other computing devices.

In SCSI command protocol, an initiator (example, a host-side endpoint of a SCSI communication) sends a command to a target (example, a storage-device-side endpoint of the SCSI communication). Generally, the initiator requests data transfers from the targets, such as disk-drives, tape-drives, optical media devices, etc. Commands are sent in a Command Description Block (CDB). By way of example, a CDB consists of several bytes (example, 10, 12, 16, etc.) having one byte of operation code followed by command-specific parameters (such as LUN, allocation length, control, etc.). SCSI currently includes four basic command categories: N (non-data), W (write data from initiator to target), R (read data from target), and B (bidirectional). Each category has numerous specific commands.

In a SCSI system, each device on a SCSI bus is assigned a logical unit number (LUN). A LUN is an address for an individual device, such as a peripheral device (example, a data storage device, disk drive, etc.). For instance, each disk drive in a disk array is provided with a unique LUN. The LUN is often used in conjunction with other addresses, such as the controller identification of the host bus adapter (HBA) and the target identification of the storage device.

SCSI devices include the HBA (i.e., device for connecting a computer to a SCSI bus) and the peripheral. The HBA provides a physical and logical connection between the SCSI bus and internal bus of the computer. SCSI devices are also provided with a unique device identification (ID). For instance, devices are interrogated for their World Wide Name (WWN). A SCSI ID (example, number in range of 0-15) is set for both the initiators and targets.

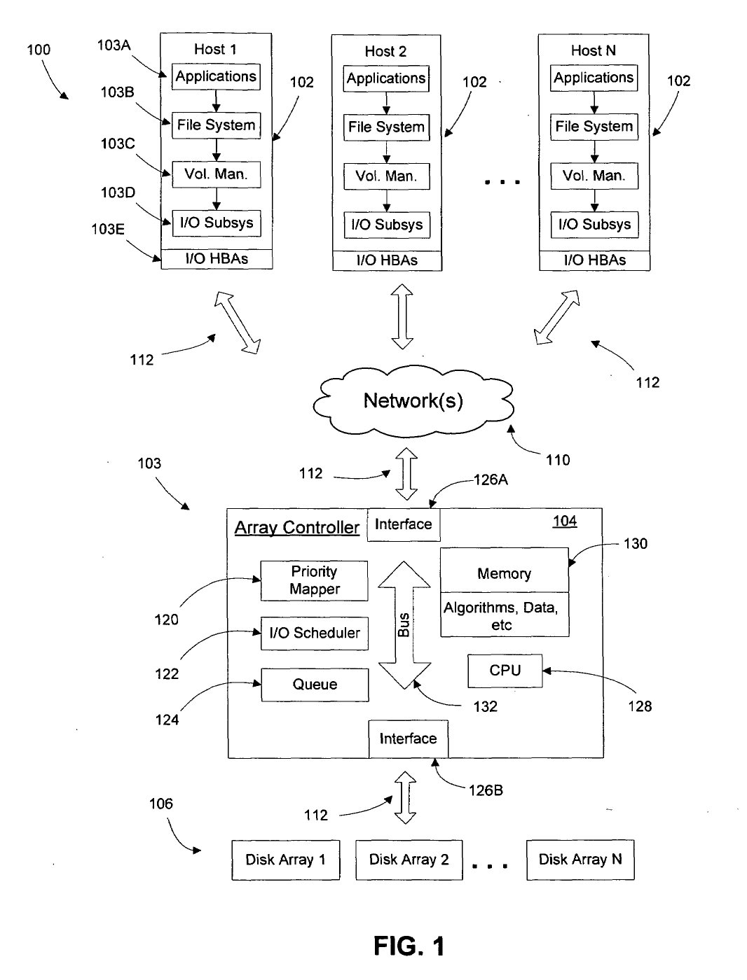

FIG. 1 is a block diagram of an exemplary distributed file or storage system 100 in accordance with an exemplary embodiment of the invention. By way of example, the system is a storage area network (SAN) that includes a plurality of host computers 102 (shown by way of example as host 1 to host N) and one or more storage devices 103 (one device being shown for illustration, but embodiments include multiple storage devices). The storage device 103 includes one or more storage controllers 104 (shown by way of example as an array controller), and a plurality of storage devices 106 (shown by way of example as disk array 1 to disk array N).

The host computers are coupled to the array controller 104 through one or more networks 110. For instance, the hosts communicate with the array controller using a small computer system interface (SCSI) bus/interface or other interface, bus, commands, etc. Further, by way of example, network 110 includes one or more of the internet, local area network (LAN), wide area network (WAN), etc. Communications links 112 are shown in the figure to represent communication paths or couplings between the hosts, controller, and storage devices. By way of example, such links include one or more SCSI buses and/or interfaces.

In one exemplary embodiment, each host 102 includes one or more of multiple applications 103A, file systems 103B, volume managers 103C, I/O subsystems 103D, and I/O HBAs 103E. For instance, if a host is a server, then each server can simultaneously run one or more different operating systems (OS) and applications (such as daemons in UNIX systems or services in Windows systems). Further, the hosts 102 can be on any combination of separate physical hardware and/or virtual computers sharing one or more HBAs. As such, storage can be virtualized at the volume manager level.

In one exemplary embodiment, the array controller 104 and disk arrays 106 are network attached devices providing random access memory (RAM) and/or disk space (for storage and as virtual RAM) and/or some other form of storage such as magnetic memory (example, tapes), micromechanical systems (MEMS), or optical disks, to name a few examples. Typically, the array controller and disk arrays include larger amounts of RAM and/or disk space and one or more specialized devices, such as network disk drives or disk drive arrays, (example, redundant array of independent disks (RAID)), high speed tape, magnetic random access memory (MRAM) systems or other devices, and combinations thereof. In one exemplary embodiment, the array controller 104 and disk arrays 106 are memory nodes that include one or more servers.

The storage controller 104 manages various data storage and retrieval operations. Storage controller 104 receives I/O requests or commands from the host computers 102, such as data read requests, data write requests, maintenance requests, etc. Storage controller 104 handles the storage and retrieval of data on the multiple disk arrays 106. In one exemplary embodiment, storage controller 104 is a separate device or may be part of a computer system, such as a server. Additionally, the storage controller 104 may be located with, proximate, or a great geographical distance from the disk arrays 106.

The array controller 104 includes numerous electronic devices, circuit boards, electronic components, etc. By way of example, the array controller 104 includes a priority mapper 120, an I/O scheduler 122, a queue 124, one or more interfaces 126, one or more processors 128 (shown by way of example as a CPU, central processing unit), and memory 130. CPU 128 performs operations and tasks necessary to manage the various data storage and data retrieval requests received from host computers 102. For instance, processor 128 is coupled to a host interface 126A that provides a bidirectional data communication interface to one or more host computers 102. Processor 128 is also coupled to an array interface 126B that provides a bidirectional data communication interface to the disk arrays 106.

Memory 130 is also coupled to processor 128 and stores various information used by processor when carrying out its tasks. By way of example, memory 130 includes one or more of volatile memory, non-volatile memory, or a combination of volatile and non-volatile memory. The memory 130, for example, stores applications, data, control programs, algorithms (including code to implement or assist in implementing embodiments in accordance with the present invention), and other data associated with the storage device. The processor 128 communicates with priority mapper 120, I/O scheduler 122, memory 130, interfaces 126, and the other components via one or more buses 132.

In at least one embodiment, the storage devices are fault tolerant by using existing replication, disk logging, and disk imaging systems and other methods including, but not limited to, one or more levels of redundant array of inexpensive disks (RAID). Replication provides high availability when one or more of the disk arrays crash or otherwise fail. Further, in one exemplary embodiment, the storage devices provide memory in the form of a disk or array of disks where data items to be addressed are accessed as individual blocks stored in disks (example, 512, 1024, 4096, etc. . . . bytes each) or stripe fragments (4K, 16K, 32K, etc. . . . each).

Embodiments in accordance with the present invention are able to reserve or manage performance capacity at the storage device 103 for individual hosts 102 or individual applications 103A executing on the hosts. In other words, performance capacity for a storage device is reserved or designated for particular hosts and/or applications running on the hosts. These tasks are accomplished by defining a relationship between a priority field and group number field in the SCSI commands.

As noted, SCSI commands generally designate the initiator, the target, the LUN, and the address. The SCSI command also includes (1) a priority field and (2) a group number field. In one exemplary embodiment, the priority field is a multi-bit field in the FCP (fiber channel protocol) command frame, and the group number field is a multi-bit field that is included in the CDBs (command descriptor blocks). The priority field represents how much of the storage device resource should be allocated to an incoming I/O, and the group number field represents or identifies the application or group of applications that generated the incoming I/O.

Looking to FIG. 1, incoming commands include priority and group number fields. These commands originate at an initiator (example, host 102 or application 103A) and are directed to a target (example, storage device 103). The commands are directed to the priority mapper 120 and then to the I/O scheduler 122.

In one exemplary embodiment, the I/O scheduler manages and schedules processor time for performing I/O requests. The scheduler balances loads and prevents any one process from monopolizing resources while other processes starve for such resources. The scheduler further performs such functions as deciding which jobs (example, I/O requests) are to be admitted to a ready queue, deciding a number or amount of processes to concurrently execute, determining how performance (example, bandwidth or I/Os per second) is divided among plural initiators (example applications 103A) so each initiator receives optimal performance, etc. Generally, the scheduler distributes storage device resources among plural initiators that are simultaneously requesting the resources. As such, resource starvation is minimized while fairness between requesting initiators is maximized.

The priority mapper 120 determines a priority for incoming I/O requests. In one exemplary embodiment, at least three different methods exist to allocate or prioritize resources for incoming I/Os. A first method allocates resources based on a value in the priority field. For example, all I/Os with priority field of A get priority X. A second method allocates resources based on a value in the group number field. For example, all I/Os with group number field B get priority Y. A third method allocates resources based on both the priority field and group number field. For example, all I/Os with priority field A and group number field B get priority Z. In this third method, the group number field and the priority field are both used to create a new priority for the incoming I/O. Some examples are further provided.

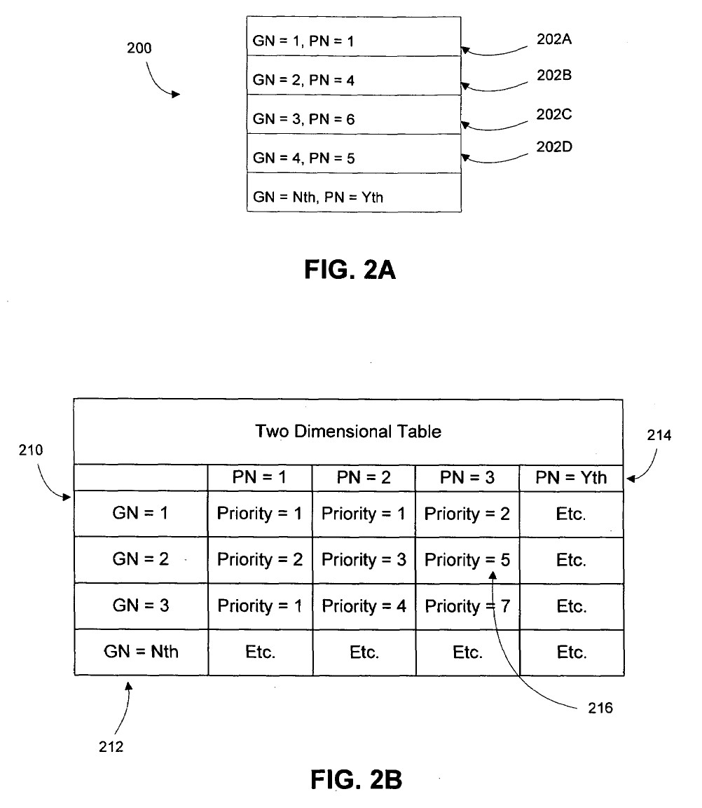

As one example, the group number is used as an index into a table of priorities. The priority indicated by the table entry at the index indicated by the group number replaces the original priority (example, the original priority in a SCSI priority field). By way of illustration, FIG. 2A shows a table 200 having a plurality of entries or cells 202A-202D, etc. Each cell has a group number (GN, example, derived from a SCSI group number field) and an associated priority level or number (PN). For instance as shown in cell 202C, if an incoming SCSI command has a group number field equal to three, then the corresponding priority is set to six. The priority established in the table can be a new priority value (i.e., different than an original priority existing in the priority field of the incoming I/O) or the same value in the original priority field of the I/O.

As another example, the group number is used as an index into one dimension of a two dimensional table, and the original priority is used as the index to the second dimension. The content of the resulting array entry replaces the original priority. By way of example, FIG. 2B shows a two-dimensional table 210 having group numbers along a side column 212 and priority numbers along a top row 214. Each cell corresponds to a priority that is based on both a given group number and priority number. For instance as shown in cell 216, if the group number is two and the priority number is 3 in the incoming I/O, then the priority number is changed or modified to five. The I/O is then executed with its new priority number determined in the table.

As another example, any combination of bits from the ITL nexus, group number, and/or priority is used as a key into a table of quality of service descriptors. The resulting descriptor includes various information including but not limited to priority, I/O usage parameters, bandwidth usage parameters, and/or other hints, such as burst or sequential access indicators.

Exemplary embodiments are not limited to any particular number of dimensions, such as a 1-dimensional table, a 2-dimensional table, etc. Instead, multiple dimensions (example, three dimensions, four dimensions, etc.) can be used to generate a new priority for incoming I/Os. In one exemplary embodiment, one or more of the following are used as a dimension to generate or calculate a priority: group number, priority number, initiator ID, target ID, LUN, address, etc.

Tables are just one exemplary means for governing how priorities are generated. Other examples include, but are not limited to, matrixes, maps and other mapping techniques, rules, if statements, etc. Further, exemplary embodiments include a wide variety of uses and means to generate priorities based on information in an I/O request. For instance, an administrator or operating system can assign particular group numbers and/or priority numbers to each host 102 or each application 103A. The group number and/or priority is then included in the I/O commands from the host or application to the target (example, storage device 103). By way of example, all applications of type I are assigned group number A and priority number B; all applications of type II are assigned group number C and priority number D; etc. In this manner, the administrator or operating system can control how servers and/or applications consume resources at the storage device. Further yet, changes to the group numbers or priority numbers are made to adjust or alter the priority number determined at the priority mapper 120. For instance, an administrator can alter the values in one of the tables of FIG. 2A or FIG. 2B to alter priorities for I/O commands from specific applications.

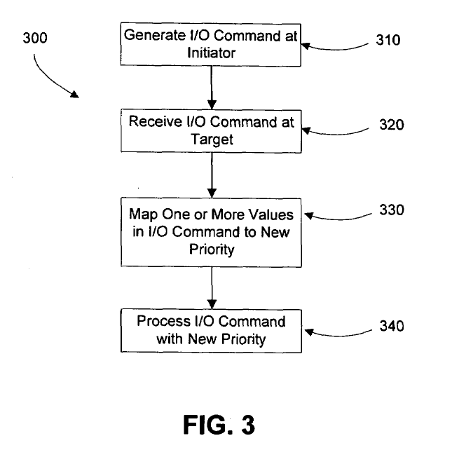

FIG. 3 is a flow diagram 300 for generating priorities for I/O commands in accordance with an exemplary embodiment of the present invention. According to block 310, an I/O command is generated at an initiator (such as a host, server, application, etc.). According to block 320, the I/O command is received at a target device (such as a SCSI storage device). According to block 330, one or more values in the I/O command is used to map a new priority. By way of example, if the I/O command follows SCSI protocol, then one or more of group number field, priority field, LUN, initiator ID, target ID, address, etc. are used to generate a new priority for the I/O command. According to block 340, the I/O command is processed at the target device in accordance with the generated new priority.

Embodiments in accordance with the present invention are not limited to any particular type or number of databases, storage device, storage system, and/or computer systems. The storage system, for example, includes one or more of various portable and non-portable computers and/or electronic devices, servers, main frame computers, distributed computing devices, laptops, and other electronic devices and systems whether such devices and systems are portable or non-portable. Further, some exemplary embodiments are discussed in connection with SCSI protocol in the context of a storage system. Exemplary embodiments, however, are not limited to any particular type of protocol or storage system. Exemplary embodiments include other protocol (example, interfaces using I/O commands) in any computing environment.

As used herein, the term “storage device” means any data storage device capable of storing data including, but not limited to, one or more of a disk array, a disk drive, a tape drive, optical drive, a SCSI device, or a fiber channel device.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method of software execution, comprising:
receiving an input/output (I/O) command having a group number and a priority number at a target device;
changing the priority number based on a value of the group number to generate a new priority number; and
processing the I/O command at the target device with the new priority number.

2) The method of claim 1 further comprising, using a two-dimensional table to map the group number and the priority number to the new priority number.

3) The method of claim 1 further comprising, mapping the value of the group number to the new priority number.

4) The method of claim 1 further comprising, using the group number as an index into one dimension of a multi-dimensional table to determine the new priority number.

5) The method of claim 1 further comprising:
assigning plural different group numbers to plural different priorities;
mapping the value of the group number to one of the plural different group numbers to determine the new priority number.

6) The method of claim 1 further comprising, generating the new priority number based on both the value of the group number and a value of the priority number.

7) The method of claim 1, wherein the I/O command is a SCSI (small computer system interface) command that includes (1) a group number field having the group number and (2) a priority field having the priority number.

8) A computer readable medium having instructions for causing a computer to execute a method, comprising:
receiving at a target device an input/output (I/O) command having a group number field and a priority number field;
generating a new priority value based on the group number field; and
processing the I/O command at the target device with the new priority value.

9) The computer readable medium of claim 8 further comprising:
associating the group number field with an index in a table of priorities;
calculating the new priority value from the table of priorities.

10) The computer readable medium of claim 8 further comprising:
determining a priority number for the priority number field;
determining a group number for the group number field;
mapping the group number and the priority number to a table to determine the new priority value.

11) The computer readable medium of claim 8 further comprising, processing the I/O command in a priority mapper in a storage device to generate the new priority value based on the group number field.

12) The computer readable medium of claim 8, wherein the I/O command is a SCSI (small computer system interface) command that includes the group number field identifying a group number and the priority number field identifying a priority number.

13) The computer readable medium of claim 8 further comprising:
assigning plural different group numbers to plural different priorities;
mapping the group number field to one of the plural different group numbers to determine the new priority value.

14) The computer readable medium of claim 8 further comprising:
mapping the group number field to one of plurals different group numbers to determine a priority of resources on a disk array for one of the plural servers.

15) The computer readable medium of claim 8 further comprising, using a two-dimensional table to map the group number field to the new priority value.

16) A storage device, comprising:
a memory for storing an algorithm; and
a processor for executing the algorithm to:
receive an input/output (I/O) request from a host computer over a SCSI (small computer system interface) interface, the I/O request having a group number and a priority for executing the I/O request; and
generate, at the storage device, a new priority for the I/O request based on a value of the group number.

17) The storage device of claim 16, wherein the processor further executes the algorithm to process the I/O request at the storage device based on the new priority.

18) The storage device of claim 16, wherein the priority is included in a four bit priority field in the I/O request and the group number is included in a five bit group number in a command descriptor block (CDB) in the I/O request.

19) The storage device of claim 16, wherein the processor further executes the algorithm to map the group number to a multi-dimensional table in order to determine the new priority.

20) The storage device of claim 16, wherein the processor further executes the algorithm to map both the group number and the priority to an index of values to calculate the new priority.
